(19) United States
(12) Patent Application Publication
(10) Pub. No.: US 2026/0167070 A1
(43) Pub. Date: Jun. 18, 2026

(54) SEAT

(71) Applicants: Hyundai Motor Company, Seoul (KR); Kia Corporation, Seoul (KR); Hyundai Transys Inc., Seosan-si (KR)

(72) Inventors: Mu Young KIM, Hwaseong-Si (KR); Hee Dong CHOI, Hwaseong-Si (KR); Seok Ju GIM, Hwaseong-Si (KR); Han Kyung PARK, Hwaseong-Si (KR); Won Yeong LEE, Hwaseong-Si (KR)

(21) Appl. No.: 19/230,661

(22) Filed: Jun. 6, 2025

(30) Foreign Application Priority Data
Dec. 18, 2024 (KR) 10-2024-0190376

(51) Int. Cl. B60N 2/30

(52) U.S. Cl. CPC B60N 2/3031; B60N 2/305

(57) ABSTRACT

A seat may comprise a base frame part, a cushion frame part provided at one side of the base frame part, a leg frame part rotatably provided at one side of the cushion frame part, a coupling part having one side coupled to the leg frame part and another side fixed relative to the base frame part, a lever part having one side rotatably coupled to the leg frame part, a cable member having one side coupled to the lever part and another side coupled to the coupling part, and an elastic connector having one side coupled to the leg frame part and another side coupled to the cushion frame part.

### CROSS-REFERENCE TO RELATED APPLICATION

This application claims the benefit of priority to Korean Patent Application No. 10-2024-0190376 filed in the Korean Intellectual Property Office on Dec. 18, 2024, the entire contents of which are incorporated herein by reference.

### TECHNICAL FIELD

The present disclosure relates to a seat, and more particularly, to a seat capable of being adjusted in posture.

### BACKGROUND

The matters described in this Background section are only for enhancement of understanding of the background of the disclosure, and should not be taken as acknowledgment that they correspond to prior art already known to those skilled in the art.

Vehicle seats may be mainly designed to focus on placing occupants in the seats. However, in the case of multipurpose vehicles, such as purpose-built vehicles (PBVs), with various utilizations, seats may be designed not only for seating occupants but also accommodating other usage scenarios.

For example, a seat may be configured to occupy minimal or reduced volume if items are loaded into a vehicle and transported. In such cases, the presence of the seat may reduce the efficiency of using the internal space of the vehicle.

### SUMMARY

The present disclosure has been made in an effort to propose a new structure capable of minimizing or reducing a volume of a space occupied by a seat for a vehicle.

According to the present disclosure, a seat may comprise a base frame part, a cushion frame part provided at one side of the base frame part, a leg frame part rotatably provided at one side of the cushion frame part, a coupling part having one side coupled to the leg frame part, and another side fixed relative to the base frame part, a lever part having one side rotatably coupled to the leg frame part, a cable member having one side coupled to the lever part, and another side coupled to the coupling part, and an elastic connector having one side coupled to the leg frame part, and another side coupled to the cushion frame part.

The seat, wherein the coupling part may comprise a first coupling part having one side coupled to the cable member and rotatably coupled to the leg frame part, and a second coupling part having one side fixed relative to the base frame part and wherein the first coupling part and the second coupling part are configured to be coupled to engage with each other.

The seat, wherein the first coupling part may comprise a hook region, and the second coupling part is configured to be caught by the hook region.

The seat, wherein the lever part may comprise a lever body member coupled to the leg frame part and configured to be rotatable about a lever rotation shaft, wherein the lever rotation shaft lies horizontally along a left-right direction of the seat, and the one side of the cable member is coupled to the lever body member.

The seat, wherein the lever body member may comprise a first lever body portion configured to be, based on the lever rotation shaft, extending toward the coupling part, and a second lever body portion configured to be, based on the lever rotation shaft, extending in a direction away from the coupling part, and wherein the cable member is coupled to one side of the first lever body portion.

The seat, wherein the lever part may further comprise a lever handle member coupled to one side of the lever body member, and the lever handle member is coupled to the one side of the first lever body portion.

The seat, wherein a first distance is a distance between the lever rotation shaft and a portion of the first lever body portion to which the lever handle member is coupled, wherein a second distance is a distance between the lever rotation shaft and a portion of the first lever body portion to which the cable member is coupled, and wherein the first distance is longer than the second distance.

The seat, wherein the lever body member may comprise a lever bent section having a bent shape. The seat, wherein the lever body member has a shape convexly protruding rearward in the lever bent section.

The seat, wherein a first distance between the lever bent section and the coupling part is shorter than a second distance between the lever rotation shaft and the coupling part.

The seat may further comprise a back frame part provided above the leg frame part and rotatably coupled to the leg frame part, and a recliner provided in a region in which the leg frame part and the back frame part are coupled, wherein the recliner is configured to, control whether the back frame part is fixed to or rotatable relative to the leg frame part, and reversibly transition between a fixed state and an unfixed state in conjunction with a motion of the lever body member, wherein the fixed state corresponds to the leg frame part and the back frame part being restricted from rotating relative to each other, and wherein the unfixed state corresponds to the leg frame part and the back frame part being rotatable relative to each other.

The seat, wherein the lever part may further comprise a lever extension member having one side coupled to the lever body member, and another side coupled to the mediation member.

The seat may further comprise an additional base frame part spaced apart from the base frame part in a widthwise direction of the seat, which extends leftward and rightward across the seat, an additional cushion frame part spaced apart from the cushion frame part in the widthwise direction and rotatably coupled to the additional base frame part, and an additional leg frame part spaced apart from the leg frame part in the widthwise direction and configured to be rotatable relative to the additional cushion frame part.

The seat may further comprise a connection link member having one side rotatably coupled to the additional leg frame part, and another side rotatably coupled to the additional base frame part.

The seat, wherein one side of the elastic connector is provided to press the leg frame part and another of the elastic connector is provided to press the cushion frame part.

According to the present disclosure, a method of transitioning a seat, the method may comprise pulling a lever part to rotate a lever body member about a lever rotation shaft, releasing a coupling part between a leg frame part and a base frame part by transmitting a pulling force through a cable member, causing a cushion frame part to rotate about a coupling with the base frame part by a pressing force from an elastic connector, causing a leg frame part, which is rotatably coupled to the cushion frame part, to rotate in conjunction with the cushion frame part, and transitioning the seat from a seating state to a folded state as the cushion frame part and the leg frame part rotate upward.

The method, wherein the releasing of the coupling may comprise rotating a first coupling member having a hook region to disengage from a second coupling member configured to be caught by the hook region.

The method, wherein the lever part may comprise a lever handle member, and the pulling of the lever part may comprise pulling the lever handle member rearward, the lever handle member being coupled to a first portion of the lever body member.

The method, wherein a distance between the lever rotation shaft and the lever handle member is longer than a distance between the lever rotation shaft and a point where the cable member is coupled to the lever body member.

The method may further comprise unlocking a recliner that couples a back frame part to the leg frame part, and transitioning, based on the rotation of the lever body member, the recliner from a fixed state to an unfixed state.

### BRIEF DESCRIPTION OF THE DRAWINGS

FIG. 1 shows an example of a perspective view of a seat according to the present disclosure.

FIG. 2 shows an exemplary view of a lateral structure of the seat according to the present disclosure if the seat is in a first state in which a person may be seated in the seat.

FIG. 3 shows an exemplary view of a lateral structure of the seat according to the present disclosure if the seat is in a second state in which the seat is folded.

FIG. 4 shows an exemplary view of a lateral structure of the seat according to the present disclosure immediately after a first coupling member and a second coupling member are uncoupled during a process in which the seat switches from the first state to the second state.

FIG. 5 shows an exemplary view of a lateral structure after a predetermined time elapses from the state in FIG. 4.

### DETAILED DESCRIPTION

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

The expression “based on” as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Units, part, and/or members herein may be implemented in software, hardware or a combination of software and hardware. The units, part, and/or members (and/or functions thereof) described herein may be implemented and/or performed by one or more processors. For examples, the units may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The units may also, or alternatively, include software control module(s) implemented with a processor and/or logic circuitry, for example. The units may include and/or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

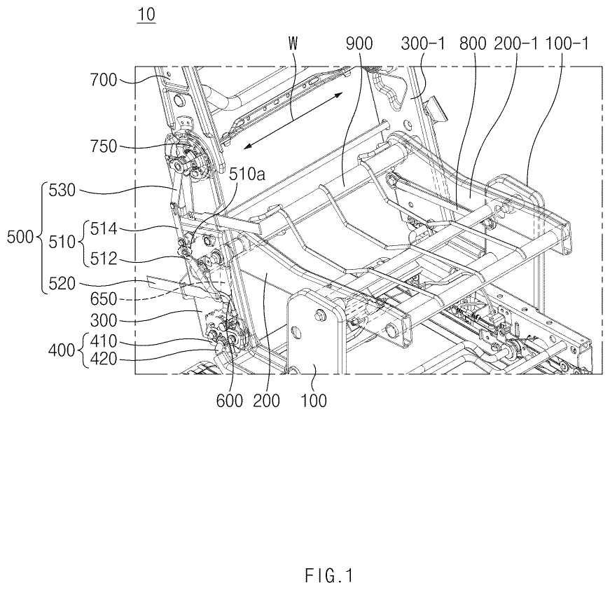

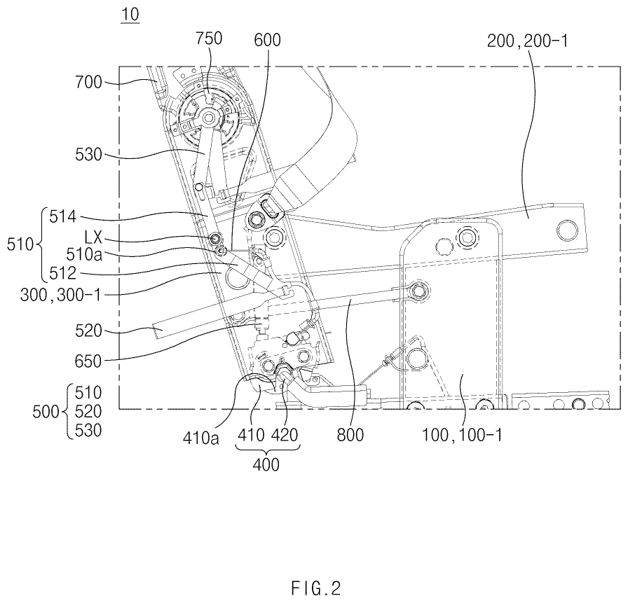

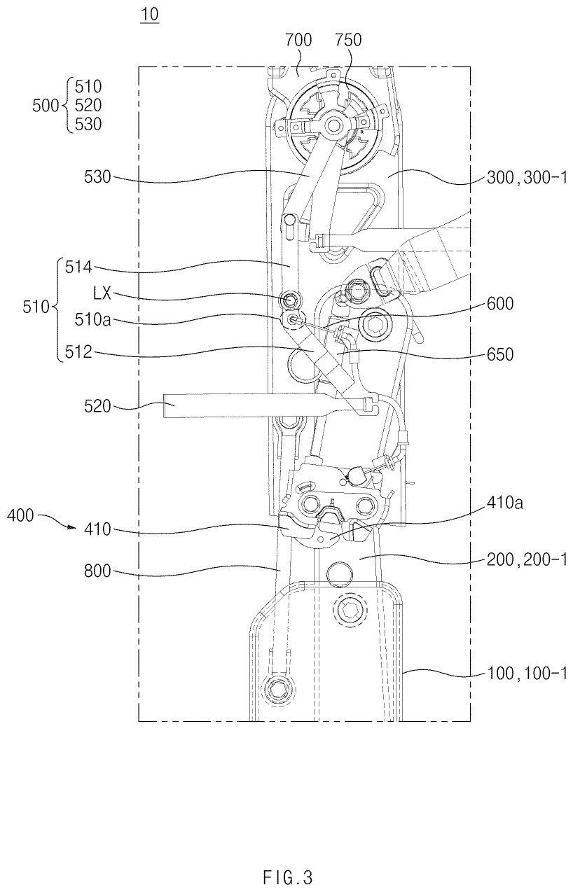

FIG. 1 shows an example of a perspective view of a seat according to the present disclosure, FIG. 2 shows an exemplary view of a lateral structure of the seat according to the present disclosure if the seat is in a first state in which a person may be seated in the seat, and FIG. 3 shows an exemplary view of a lateral structure of the seat according to the present disclosure if the seat is in a second state in which the seat is folded.

The seat according to the present disclosure may be a seat having a structure capable of being adjusted in posture (e.g., for reconfiguration between use and storage modes, etc.). More specifically, the seat according to the present disclosure may have a structure that may reversibly switch between the first state in which the person may be seated in the seat and the second state in which the seat is folded (e.g., upright or compactly stowed, etc.). In particular, according to the present disclosure, the seat may have a structure in which a width in a forward/rearward direction may be minimized in the above-mentioned second state (e.g., allowing more cabin space for cargo, standing passengers, or modular reconfigurations, etc.). Therefore, according to the present disclosure, it is possible to minimize a volume occupied by the seat in a situation in which the person does not need to be seated in the seat (e.g., in case that items need to be loaded around the seat if transporting large luggage, loading delivery goods, or accommodating alternative seating, etc.). The seat according to the present disclosure may be mounted in a movable body such as a vehicle (e.g., a passenger car, van, bus, or purpose-built vehicle (PBV), etc.). However, the seat according to the present disclosure may be used in various places where the seat is needed (e.g., in trains, aircraft, modular living spaces, mobile offices, or temporary installations in event venues, etc.).

With reference to FIGS. 1 to 3, a seat 10 according to the present disclosure may include a base frame part 100. The base frame part 100 may be fixed to a floor (e.g., a floor of the movable body such as the vehicle, a cabin floor of a vehicle). The base frame part 100 may be fixed to the floor without moving while the seat switches between the first state and the second state. The base frame part 100 may protrude upward or extend vertically or obliquely upward from the above-mentioned floor.

In addition, the seat 10 according to the present disclosure may further include a cushion frame part 200 provided at one side of the base frame part 100 (e.g., the rear side or upper portion depending on seat orientation, etc.). More specifically, the cushion frame part 200 may be rotatably coupled to the base frame part 100 (e.g., via a hinge, pivot bracket, or bushing-supported shaft, etc.). More particularly, a rotary shaft, which is used to couple the cushion frame part 200 and the base frame part 100, may be provided in parallel with a leftward/rightward direction W of the seat 10 (e.g., extending laterally across the seat width to enable smooth folding motion, etc.). The cushion frame part 200 may be configured to support the person's lower body (e.g., thighs, hips, or buttocks, etc.) if the person is seated in the seat. More specifically, the cushion frame part 200 may be disposed to extend in a direction close to a forward/rearward direction in the above-mentioned first state (e.g., providing a horizontal seating surface for occupant support, etc.), and the cushion frame part 200 may be disposed to extend in an upward/downward direction in the above-mentioned second state (e.g., forming a vertically aligned profile for compact stowage or standing mode, etc.).

In addition, the seat 10 may further include a leg frame part 300 rotatably provided at one side of the cushion frame part 200 (e.g., at a rear or lower end of the cushion frame depending on structural configuration, etc.). The leg frame part 300 may be rotatably coupled to a rear region of the cushion frame part 200 (e.g., to enable coordinated movement during folding or unfolding operations, etc.). More particularly, a rotary shaft, which is used to couple the cushion frame part 200 and the leg frame part 300, may be provided in parallel with the leftward/rightward direction W of the seat 10 (e.g., allowing lateral pivoting motion along a horizontal axis extending across the seat width, etc.). A partial region of the leg frame part 300 may be configured to support a rear surface portion of the person, who is seated in the seat, together with a back frame part to be described below (e.g., upper thighs, buttocks, or pelvic area, etc.). More specifically, the leg frame part 300 may be disposed to extend in a direction inclined rearward in the above-mentioned first state, and the leg frame part 300 may be disposed to extend in the upward/downward direction in the above-mentioned second state, for example, to allow vertical stowing with minimal intrusion into the cabin space.

With continued reference to FIGS. 1 to 3, the seat may further include a coupling part 400 having one side coupled to the leg frame part 300, and another side fixed with respect to the base frame part 100. In this case, the configuration in which the other side of the coupling part 400 is fixed relative to the base frame part 100 does not necessarily mean a configuration in which the other side of the coupling part 400 is coupled directly to the base frame part 100. Rather, with reference to FIGS. 1 to 3, the other side of the coupling part 400 may be fixed to the floor on which the seat is provided (e.g., via an intermediate bracket, subframe, mounting plate, or base rail, etc.). A detailed configuration of the coupling part 400 will be described below after the following configurations are described first.

In addition, the seat 10 according to the present disclosure may further include a lever part 500 having one side rotatably coupled to the leg frame part 300, and a cable member 600 having one side coupled to the lever part 500, and another side coupled to the coupling part 400 (e.g., a latch, hook, or locking mechanism of the coupling part, etc.).

According to the present disclosure, if the seat 10 is in the above-mentioned first state, both one side and the other side of the coupling part 400 may be coupled to each other (e.g., via a latch-and-striker, hook-and-slot, or cam-lock engagement, etc.). In this case, if the person pulls the lever part 500 so that the seat 10 switches to the above-mentioned second state, the lever part 500 pulls the cable member 600, such that one side of the coupling part 400 connected to the cable member 600 is actuated to perform a motion (e.g., rotate, slide, or retract, etc.). Therefore, one side and the other side of the coupling part 400 may be uncoupled, and the leg frame part 300, to which one side of the coupling part 400 is coupled, may move upward (e.g., pivoting about a hinge axis into a vertical orientation, etc.).

The coupling part 400 may include a first coupling member 410 having one side connected to the cable member 600 and being rotatably coupled to the leg frame part 300, and a second coupling member 420 having one side fixed relative to the base frame part 100 (e.g., directly mounted to the base frame, attached via a support bracket, or secured to the vehicle floor, etc.). For example, one side of the coupling part 400 may correspond to the first coupling member 410 (e.g., a latch, hook, or movable pin, etc.), and the other side of the coupling part 400 may correspond to the second coupling member 420 (e.g., a striker, groove, or fixed catch, etc.).

According to the present disclosure, the first coupling member 410 and the second coupling member 420 may be coupled to engage with each other (e.g., via latch-hook engagement, snap-fit locking, or rotary interlocking, etc.). For example, according to the present disclosure, if the seat is in the above-mentioned first state, the first coupling member 410 and the second coupling member 420 may physically engage with each other, such that the leg frame part 300 may be fixed to the floor on which the seat 10 is provided (e.g., to stabilize the seat during occupancy or vehicle motion, etc.). Then, if the person manipulates the lever part 500, the first coupling member 410 may be rotated by the cable member 600, and the first coupling member 410 and the second coupling member 420 may be uncoupled, such that the cushion frame part 200 and the leg frame part 300 may rotate relative to the base frame part 100 and the cushion frame part 200, allowing the seat to switch to the above-mentioned second state (e.g., a folded or standing position for space-saving purposes, etc.).

For example, as illustrated in FIGS. 1 to 3, the first coupling member 410 may be provided as a latch member including a hook region 410a (e.g., formed integrally with the latch member as a recessed groove, angled notch, or contoured projection, etc.), and the second coupling member 420 may be provided as a striker member configured to be caught by the hook region 410a (e.g., a protruding bar, peg, or mating tab, etc.).

With continued reference to FIGS. 1 to 3, the seat 10 according to the present disclosure may include an elastic member 650 (e.g., an elastic connector) having one side connected to the leg frame part 300, and the other side connected to the cushion frame part 200. The elastic member 650 may be configured to press the cushion frame part 200 and the leg frame part 300, for example, toward respective rotation directions during seat folding or unfolding. That is, one side of the elastic member 650 may be provided to press the leg frame part 300, and the other side of the elastic member 650 may be provided to press the cushion frame part 200 (e.g., via brackets, mounting tabs, or linkages, etc.). More specifically, in the state in which the seat is in the above-mentioned first state, one side of the elastic member 650 may be coupled to a lower region of the leg frame part 300, and the other side of the elastic member 650 may be coupled to a rear region of the cushion frame part 200 (e.g., adjacent to the hinge axis or near the back edge, etc.). For example, in the above-mentioned first state, one side of the elastic member 650 may be provided below the other side of the elastic member 650, and the entire elastic member 650 may be disposed in the upward/downward direction (e.g., vertically aligned or slightly inclined depending on seat layout, etc.).

As described above, in case that the first coupling member 410 and the second coupling member 420 are uncoupled by the manipulation of the lever part 500, the rear region of the cushion frame part 200 is pressed upward by the elastic member 650 (e.g., by stored spring force or compressed gas pressure, etc.). Therefore, the cushion frame part 200 may rotate about the region coupled to the base frame part 100 so that the rear region of the cushion frame part 200 may move upward (e.g., pivoting around the first hinge axis, etc.). Therefore, the cushion frame part 200 may be disposed in the upward/downward direction, such that the seat may be in the above-mentioned second state (e.g., a folded or stowed standing position, etc.). For example, the elastic member 650 may be a gas spring (e.g., a sealed cylinder with a pressurized gas chamber and a sliding rod, etc.). However, the type of elastic member 650 is not limited to the gas spring, and any elastic member may be applied (e.g., a coil spring, torsion spring, or elastomeric damper, etc.) as long as the elastic member may apply an elastic force.

The lever part 500 may include a plurality of components. That is, the lever part 500 may include a lever body member 510 coupled to the leg frame part 300 and configured to be rotatable about a lever rotation shaft LX (e.g., a fixed pivot pin, hinge axis, or bushing-supported shaft, etc.). One side of the cable member 600 may be connected to the lever body member 510 (e.g., via a hook, clamp, or crimped fitting, etc.). According to the present disclosure, if the person manipulates the lever part 500, the lever body member 510 may rotate about the lever rotation shaft LX to transmit motion for releasing one or more locking components. More particularly, the lever rotation shaft LX may be provided in a direction parallel to the leftward/rightward direction W (i.e., a lateral direction across the seat width, etc.).

The lever body member 510 may include a first lever body portion 512, i.e., a portion extending toward the coupling part 400 (i.e., downward based on FIGS. 1 to 3) based on the lever rotation shaft LX, and a second lever body portion 514, i.e., a portion extending in a direction away from the coupling part 400 based on the lever rotation shaft LX (e.g., upward or rearward depending on mounting orientation, etc.). In this case, the cable member 600 may be connected to one side (e.g., one end) of the first lever body portion 512 (e.g., where mechanical advantage is optimized for pulling the cable, etc.).

In addition, the lever part 500 may further include a lever handle member 520 connected to one side or a side portion of the lever body member 510 (e.g., via welding, bolting, or integral molding, etc.). The lever handle member 520 may be configured to be grasped directly by the person when the person manipulates the lever part 500 (e.g., to initiate seat folding, unlatching, or reclining, etc.). The lever handle member 520 may be connected to one side (e.g., one end) of the first lever body portion 512. More particularly, the lever handle member 520 may extend from a lower end of the first lever body portion 512 toward a rear side of the seat (e.g., in a direction convenient for user pulling during seat operation, etc.).

In this case, according to the present disclosure, i) a distance between the lever rotation shaft LX and the portion of the first lever body portion 512 to which the lever handle member 520 is connected may be longer than ii) a distance between the lever rotation shaft LX and the portion of the first lever body portion 512 to which the cable member 600 is connected (e.g., establishing a torque arm ratio favorable for efficient cable actuation, etc.). This may be to move rearward the region of the cable member 600 connected to the first lever body portion 512 when the person pulls the lever handle member 520 rearward (e.g., allowing coordinated latch release through mechanical advantage, enabling synchronized unlatching, improving ergonomic leverage, or reducing required user force, etc.).

The lever body member 510 may have a shape that is generally bent as a whole. More specifically, the lever body member 510 may include a lever bent section 510a having a bent shape (e.g., an angled elbow, curved junction, or recessed contour, etc.). In this case, with reference to FIGS. 1 to 3, the lever body member 510 may have a shape that convexly protrudes rearward in the lever bent section 510a (e.g., forming a rearward arc or hump, etc.). In the drawings, for example, i) a distance between the lever bent section 510a and the coupling part 400 may be shorter than ii) a distance between the lever rotation shaft LX and the coupling part 400, and the cable member 600 may be connected to the lever bent section 510a (e.g., to achieve optimal pull angle, compact packaging, or clearance from surrounding structures, etc.).

With continued reference to FIGS. 1 to 3, the seat may further include a back frame part 700 provided above the leg frame part 300 and rotatably coupled to the leg frame part 300 (e.g., via a hinge joint, pivot pin, or recliner mechanism, etc.), and a mediation member 750 (e.g., a recliner, a latch, a detent, a rotation detent, etc.) provided in a region in which the leg frame part 300 and the back frame part 700 are connected, the mediation member 750 being configured to mediate coupling between the leg frame part 300 and the back frame part 700 (e.g., to selectively lock or unlock the back frame part 700 with respect to the leg frame part 300, to control whether the back frame part 700 is fixed to or rotatable relative to the leg frame part 300, to control reclining or folding operations, adjust angular positioning, or enable locking during use, etc.). More specifically, the mediation member 750 may be provided in the region in which the leg frame part 300 and the back frame part 700 are rotatably connected (e.g., via a hinge, pivot pin, or articulated joint, etc.). In this case, the mediation member 750 may be configured such that i) a fixed state in which the leg frame part 300 and the back frame part 700 are fixedly coupled to each other (e.g., being restricted from rotating relative to each other) and ii) an unfixed state in which the leg frame part 300 and the back frame part 700 may rotate relative to each other may be reversibly repeated in conjunction with the motion of the lever body member 510 (e.g., to allow backrest recline or upright stowage, seat folding for compact storage, or ergonomic adjustment, etc.). The above-mentioned mediation member 750 may be a recliner (e.g., a ratcheting gear, torsion-damped recliner, or cam-lock mechanism, etc.). Alternatively, the mediation member 750 may be substituted with a locking member such as a latch member (e.g., spring-loaded pin or hook latch, etc.).

The lever part 500 may further include a lever extension member 530 extending upward from the lever body member 510 and having one side coupled to the lever body member 510, and the other side connected to the mediation member 750 (e.g., a recliner or locking unit positioned between the leg frame and back frame, etc.). More specifically, the lever extension member 530 may be coupled to one side of the second lever body portion 514 (e.g., near its upper end or intermediate region, etc.). Therefore, in case that the lever body member 510 rotates, the lever extension member 530 may also rotate together with the lever body member 510 (e.g., through direct attachment or a shared pivot, etc.). Therefore, the mediation member 750 connected to the lever extension member 530 may also rotate (e.g., to change between locked and unlocked states, etc.). Therefore, according to the present disclosure, in case that the person manipulates the lever handle member 520 and rotates the lever body member 510 if the seat 10 is in the above-mentioned first state, i) the first coupling member 410 and the second coupling member 420 may be uncoupled by the first lever body portion 512, and simultaneously ii) the leg frame part 300 and the back frame part 700, which are fixedly coupled by the mediation member 750, may also be unfixed by the second lever body portion 514 (e.g., enabling both latch release and recliner disengagement in a single user action for streamlined folding or stowing of the seat, etc.).

The seat 10 according to the present disclosure may include the components spaced apart from one another in the leftward/rightward direction W and corresponding to one another (e.g., for symmetrical support, enhanced stability, or dual-side actuation, etc.).

For example, the seat 10 may further include an additional base frame part 100-1 spaced apart from the base frame part 100 in the leftward/rightward direction W and corresponding to the base frame part 100, an additional cushion frame part 200-1 spaced apart from the cushion frame part 200 in the leftward/rightward direction W, corresponding to the cushion frame part 200, and rotatably coupled to the additional base frame part 100-1, and an additional leg frame part 300-1 spaced apart from the leg frame part 300 in the leftward/rightward direction W, corresponding to the leg frame part 300, and configured to be rotatable relative to the additional cushion frame part 200-1 (e.g., forming a mirrored linkage on the opposite side of the seat structure for balanced operation, synchronized motion, or structural stability,, etc.). The above-mentioned descriptions of the base frame part 100, the cushion frame part 200, and the leg frame part 300 may be basically and equally applied to the additional base frame part 100-1, the additional cushion frame part 200-1, and the additional leg frame part 300-1 (e.g., using similar pivot points, material types, or movement ranges, etc.). Unlike the configuration illustrated in FIG. 1, FIGS. 2 and 3 illustrate, for convenience of description, that the base frame part 100 and the additional base frame part 100-1 are integrated into a single component, and the leg frame part 300 and the additional leg frame part 300-1 are integrated into a single component (e.g., as a unified structural member or simplified for drawing clarity, etc.).

According to the present disclosure, the seat may further include a connection link member 800 having one side rotatably coupled to the additional leg frame part 300-1, and the other side rotatably coupled to the additional base frame part 100-1 (e.g., via hinge pins, bushings, or ball joints, etc.). According to the present disclosure, the additional base frame part 100-1, the additional cushion frame part 200-1, the additional leg frame part 300-1, and the connection link member 800 may constitute a four-joint link (e.g., forming a mechanical four-bar linkage to ensure synchronized motion, etc.). Therefore, as described above, if the first coupling member 410 and the second coupling member 420 are uncoupled as the person manipulates the lever part 500, the cushion frame part 200 and the leg frame part 300 may rotate, and the connection link member 800 may rotate while corresponding to the rotation (e.g., in coordination with the other components to maintain structural alignment and smooth folding behavior).

In addition, the seat 10 according to the present disclosure may further include a shaft member configured to allow the motions of the cushion frame part 200 and the leg frame part 300 and the motions of the additional cushion frame part 200-1 and the additional leg frame part 300-1 to be performed in conjunction with one another (e.g., to maintain symmetry, synchronization, and mechanical stability between left and right sides, etc.). More specifically, the seat may further include a connection shaft member 900 extending in the leftward/rightward direction W and configured to sequentially penetrate the leg frame part 300, the cushion frame part 200, the additional cushion frame part 200-1, and the additional leg frame part 300-1 (e.g., through coaxial hinge points or bushing assemblies, etc.). For example, the leg frame part 300, the cushion frame part 200, the additional cushion frame part 200-1, and the additional leg frame part 300-1 may rotate about the connection shaft member 900 (e.g., in response to a single actuation event such as lever manipulation, etc.). The connection shaft member 900 may also rotate in conjunction with the motions of the leg frame part 300 and the cushion frame part 200. The motions of the additional cushion frame part 200-1 and the additional leg frame part 300-1 may be performed in conjunction with the cushion frame part 200 and the leg frame part 300 in accordance with the rotation of the connection shaft member 900 (e.g., enabling mirrored folding action on both seat sides with minimal offset or lag, etc.).

Hereinafter, the shape and structure of the seat during the process in which the seat switches from the state (i.e., the first state) in FIG. 1 to the state (i.e., the second state) in FIG. 2 will be described (e.g., a transition from a seated-use configuration to a space-saving folded configuration, etc.).

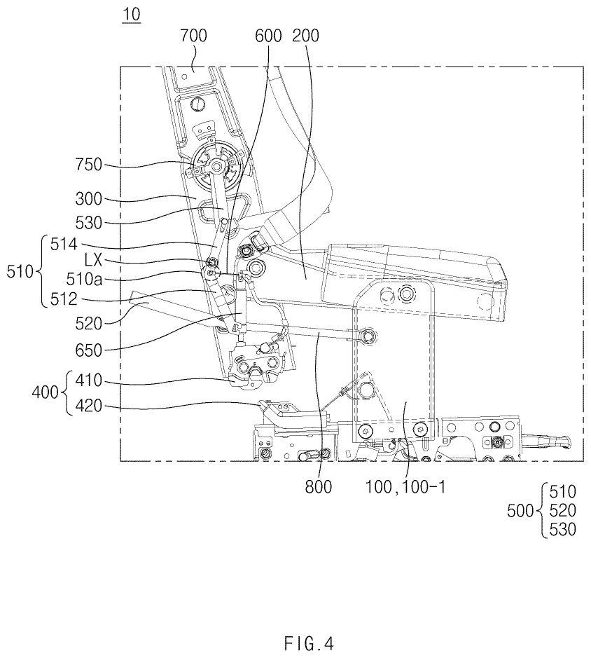

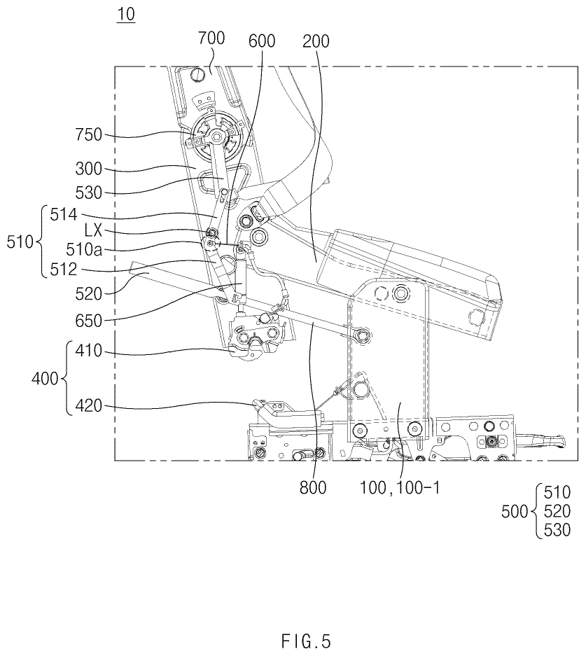

When the person manipulates the lever handle member 520 and when the seat 10 is in the state in FIG. 1, i) the first coupling member 410 and the second coupling member 420 are uncoupled, and simultaneously ii) the leg frame part 300 and the back frame part 700, which are coupled by the mediation member 750, are uncoupled, such that a physical distance between the first coupling member 410 and the second coupling member 420 increases, and the back frame part 700 rotates forward relative to the leg frame part 300 (e.g., enabling transition toward a compact stowed state, see FIG. 4). For example, if the first coupling member 410 and the second coupling member 420 are uncoupled, the rear region of the cushion frame part 200 is rotated while being moved upward by a pressing force of the elastic member 650 that presses the cushion frame part 200 and the leg frame part 300 (e.g., a gas spring or coil spring providing upward bias, etc.), such that the leg frame part 300 rotatably coupled to the cushion frame part 200 also rotates (e.g., pivoting about the second hinge axis to support the folding sequence, see FIG. 5). Thereafter, the elastic member 650 consistently presses the cushion frame part 200, such that the seat 10 reaches the second state, as illustrated in FIG. 3 (e.g., a fully standing position with reduced volume footprint, etc.).

One example of the present disclosure provides a seat including: a base frame part; a cushion frame part provided at one side of the base frame part; a leg frame part rotatably provided at one side of the cushion frame part; a coupling part having one side coupled to the leg frame part, and the other side fixed relative to the base frame part; a lever part having one side rotatably coupled to the leg frame part; a cable member having one side connected to the lever part, and the other side connected to the coupling part; and an elastic member having one side connected to the leg frame part, and the other side connected to the cushion frame part.

The coupling part may include: a first coupling member having one side connected to the cable member and rotatably coupled to the leg frame part; and a second coupling member having one side fixed relative to the base frame part, and the first coupling member and the second coupling member may be configured to be coupled to engage with each other.

The first coupling member may be provided as a latch member including a hook region, and the second coupling member may be provided as a striker member configured to be caught by the hook region.

The lever part may include a lever body member coupled to the leg frame part and configured to be rotatable about a lever rotation shaft LX, and one side of the cable member may be connected to the lever body member.

The lever body member may include: a first lever body portion that is a portion extending toward the coupling part based on the lever rotation shaft LX; and a second lever body portion that is a portion extending in a direction away from the coupling part based on the lever rotation shaft LX, and the cable member may be connected to one side of the first lever body portion.

The lever part may further include a lever handle member connected to one side of the lever body member, and the lever handle member may be connected to one side of the first lever body portion.

i) A distance between the lever rotation shaft LX and a portion of the first lever body portion to which the lever handle member is connected may be longer than ii) a distance between the lever rotation shaft LX and a portion of the first lever body portion to which the cable member is connected.

The lever body member may include a lever bent section having a bent shape.

The lever body member may have a shape convexly protruding rearward in the lever bent section.

i) A distance between the lever bent section and the coupling part may be shorter than ii) a distance between the lever rotation shaft LX and the coupling part.

The seat may further include: a back frame part provided above the leg frame part and rotatably connected to the leg frame part; and a mediation member provided in a region in which the leg frame part and the back frame part are connected, the mediation member being configured to mediate coupling between the leg frame part and the back frame part, in which the mediation member is configured such that i) a fixed state in which the leg frame part and the back frame part are fixedly coupled to each other (e.g., being restricted from rotating relative to each other) and ii) an unfixed state in which the leg frame part and the back frame part are rotatable relative to each other are reversibly repeated in conjunction with a motion of the lever body member.

The lever part may further include a lever extension member having one side coupled to the lever body member, and the other side connected to the mediation member.

The seat may further include: an additional base frame part spaced apart from the base frame part in a leftward/rightward direction W; an additional cushion frame part spaced apart from the cushion frame part in the leftward/rightward direction W and rotatably coupled to the additional base frame part; and an additional leg frame part spaced apart from the leg frame part in the leftward/rightward direction W and configured to be rotatable relative to the additional cushion frame part.

The seat may further include: a connection link member having one side rotatably coupled to the additional leg frame part, and the other side rotatably coupled to the additional base frame part.

One side of the elastic member may be provided to press the leg frame part, and the other side of the elastic member may be provided to press the cushion frame part.

According to the present disclosure, the volume of the space occupied by the seat for a vehicle may be minimized or reduced, which may improve the utilization of the internal space of the vehicle.

The present disclosure has been described with reference to the limited examples and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed:

1. A seat comprising:
a base frame part;
a cushion frame part provided at one side of the base frame part;
a leg frame part rotatably provided at one side of the cushion frame part;
a coupling part having one side coupled to the leg frame part, and another side fixed relative to the base frame part;
a lever part having one side rotatably coupled to the leg frame part;
a cable member having one side coupled to the lever part, and another side coupled to the coupling part; and
an elastic connector having one side coupled to the leg frame part, and another side coupled to the cushion frame part.

2. The seat of claim 1, wherein the coupling part comprises:
a first coupling part having one side coupled to the cable member and rotatably coupled to the leg frame part; and
a second coupling part having one side fixed relative to the base frame part and
wherein the first coupling part and the second coupling part are configured to be coupled to engage with each other.

3. The seat of claim 2, wherein the first coupling part comprises a hook region, and the second coupling part is configured to be caught by the hook region.

4. The seat of claim 1, wherein the lever part comprises a lever body member coupled to the leg frame part and configured to be rotatable about a lever rotation shaft, wherein the lever rotation shaft lies horizontally along a left-right direction of the seat, and the one side of the cable member is coupled to the lever body member.

5. The seat of claim 4, wherein the lever body member comprises:
a first lever body portion configured to be, based on the lever rotation shaft, extending toward the coupling part; and
a second lever body portion configured to be, based on the lever rotation shaft, extending in a direction away from the coupling part, and
wherein the cable member is coupled to one side of the first lever body portion.

6. The seat of claim 5, wherein the lever part further comprises a lever handle member coupled to one side of the lever body member, and the lever handle member is coupled to the one side of the first lever body portion.

7. The seat of claim 6, wherein a first distance is a distance between the lever rotation shaft and a portion of the first lever body portion to which the lever handle member is coupled, wherein a second distance is a distance between the lever rotation shaft and a portion of the first lever body portion to which the cable member is coupled, and wherein the first distance is longer than the second distance.

8. The seat of claim 4, wherein the lever body member comprises a lever bent section having a bent shape.

9. The seat of claim 8, wherein the lever body member has a shape convexly protruding rearward in the lever bent section.

10. The seat of claim 8, wherein a first distance between the lever bent section and the coupling part is shorter than a second distance between the lever rotation shaft and the coupling part.

11. The seat of claim 4, further comprising:
a back frame part provided above the leg frame part and rotatably coupled to the leg frame part; and
a recliner provided in a region in which the leg frame part and the back frame part are coupled, wherein the recliner is configured to:
control whether the back frame part is fixed to or rotatable relative to the leg frame part, and
reversibly transition between a fixed state and an unfixed state in conjunction with a motion of the lever body member, wherein the fixed state corresponds to the leg frame part and the back frame part being restricted from rotating relative to each other, and wherein the unfixed state corresponds to the leg frame part and the back frame part being rotatable relative to each other.

12. The seat of claim 11, wherein the lever part further comprises a lever extension member having one side coupled to the lever body member, and another side coupled to the mediation member.

13. The seat of claim 1, further comprising:
an additional base frame part spaced apart from the base frame part in a widthwise direction of the seat, which extends leftward and rightward across the seat;
an additional cushion frame part spaced apart from the cushion frame part in the widthwise direction and rotatably coupled to the additional base frame part; and
an additional leg frame part spaced apart from the leg frame part in the widthwise direction and configured to be rotatable relative to the additional cushion frame part.

14. The seat of claim 13, further comprising:
a connection link member having one side rotatably coupled to the additional leg frame part, and another side rotatably coupled to the additional base frame part.

15. The seat of claim 1, wherein one side of the elastic connector is provided to press the leg frame part and another of the elastic connector is provided to press the cushion frame part.

16. A method of transitioning a seat, the method comprising:
pulling a lever part to rotate a lever body member about a lever rotation shaft;
releasing a coupling part between a leg frame part and a base frame part by transmitting a pulling force through a cable member;
causing a cushion frame part to rotate about a coupling with the base frame part by a pressing force from an elastic connector;
causing a leg frame part, which is rotatably coupled to the cushion frame part, to rotate in conjunction with the cushion frame part; and
transitioning the seat from a seating state to a folded state as the cushion frame part and the leg frame part rotate upward.

17. The method of claim 16, wherein the releasing of the coupling comprises rotating a first coupling member having a hook region to disengage from a second coupling member configured to be caught by the hook region.

18. The method of claim 16, wherein the lever part comprises a lever handle member, and the pulling of the lever part comprises pulling the lever handle member rearward, the lever handle member being coupled to a first portion of the lever body member.

19. The method of claim 18, wherein a distance between the lever rotation shaft and the lever handle member is longer than a distance between the lever rotation shaft and a point where the cable member is coupled to the lever body member.

20. The method of claim 16, further comprising:
unlocking a recliner that couples a back frame part to the leg frame part; and
transitioning, based on the rotation of the lever body member, the recliner from a fixed state to an unfixed state.
